(19) United States
(12) Patent Application Publication
(10) Pub. No.: US 2006/0251370 A1
(43) Pub. Date: Nov. 9, 2006

(54) Optical fiber coated with metal

(75) Inventors: Yoichi Onosato, Tokyo (JP); Keisuke Wada, Tokyo (JP)

Correspondence Address: PILLSBURY WINTHROP SHAW PITTMAN, LLP, P.O. BOX 10500, MCLEAN, VA, 22102, US

(73) Assignee: Sumitomo Metal Mining Co., Ltd., Tokyo (JP)

(21) Appl. No.: 10/504,864

(22) PCT Filed: Feb. 14, 2003
(86) PCT No.: PCT/JP03/01545

§ 371 Date: Mar. 16, 2005

(30) Foreign Application Priority Data
Feb. 18, 2002 (JP) 2002-39675

(51) Int. Cl. G02B 6/036

(52) U.S. Cl. 385/128

(57) ABSTRACT

On the surface of the optical fiber core wire 1 where plastic cover is removed, a foundation layer comprising 0.01-0.5 μm of an electroless Ni plating layer 2, 0.5-4.0 μm of an inner layer comprising an electrolytic Ni plating layer 3 and 0.05-1 μm of an outermost layer comprising an electrolytic Au layer 4 are formed.

### TECHNICAL FIELD

The present invention relates to finishing an optical fiber core wire connected with an optical element which is used for optical communications and optical measurement and the like and an optical fiber which is coated on the surface of the optical fiber core wire with metal in order to air-tightly seal the housing by solder in a through-part of the housing which houses an optical element.

### BACKGROUND ART

The housing in which an optical element such as laser diode is housed should be shut off from the outside world in order to prevent destruction of the optical element by dew condensation and the like. Consequently, when an optical fiber is lead in the housing which houses the optical element and a through-part of the housing is air-tightly sealed, a method which coats on the surface of the optical fiber core wire with metal and solder the coated part directly or indirectly with the housing wall is applied.

As for a method which coats the surface of the optical fiber core wire with metal, the method which, after forming 1 μm of the Ni layer as a foundation layer by electroless plating on the surface of the optical fiber wherein the plastic cover is removed, forms the Au layer by electrolysis plating is disclosed in JP KOKAI HEI 07-244232 and JP KOKAI HEI 10-300997.

Furthermore, besides the above-mentioned methods, a method which forms the carbon layer which on the surface of the optical core wire as foundation layer and forms the Ni layer and the Au layer by electrolysis plating thereon is disclosed in JP KOKAI HE31I05-249653.

However, if an electroless Ni plating layer is made to be a foundation layer, because the internal stress and degree of hardness of the electroless Ni plating are high, it is a problem that the plasticity of the optical fiber becomes impaired. In addition, it is a problem that metal coating is easy to peel when the optical fiber is bent. Generally, electroless plating has a replacement type which replaces basis metal with plated metal and a reduction type which uses reducing agent. But, the replacement type occludes molten basis metal and the reduction type occludes a part of reducing agent, therefore, a high-purity deposition layer cannot be obtained. Correspondingly, the electroless plating becomes a plating layer wherein internal stress and degree of hardness are high and which is easy to peel.

Furthermore, if a carbon layer is made to be a foundation layer, because the carbon layer is vulnerable and adherence of the surface of the optical fiber core wire to quarts is weak, it is a problem that the metal coating which is formed thereon peels.

Among other methods for coating the surface of the optical fiber with metal, generally, there is dry plating such as vapour coating and sputtering. But, in such dry plating, material may be damaged because the temperature around the coated part becomes high, furthermore, it is a problem that distribution occurs on the film thickness and thereby uniform plating cannot be made, and an equipment with large size of vacuum vessels is required and thereby the cost becomes high.

### DISCLOSURE OF THE INVENTION

The present invention intends to provide a metal-coated optical fiber which is coated with metal on the surface of the optical fiber core wire wherein the plasticity is not impaired and the adherence to the optical fiber is strong, what is more, the soldering ability is good.

The inventors have found that the metal-coated optical fiber which is coated with metal on the surface of the optical fiber core wire wherein the plasticity is not impaired and the adherence to the optical fiber is strong, what is more, the soldering ability is good can be obtained by forming an electroless Ni plating layer which has a minimum thickness necessary to give an electrolytic plating after inner layer on the surface of the optical fiber core wire wherein the plastic cover is removed, and forming thereon a inner layer comprising electrolytic Ni plating layer wherein the internal stress is low because of high-purity, having more plasticity and difficult to peel and an outermost layer comprising electrolytic Au plating layer.

The metal-coated optical fiber according to the invention is characterized in that, on the surface of the optical fiber core wire wherein the plastic cover is removed, a foundation layer comprising 0.1-1.0 of an electroless Ni plating layer, an inner layer comprising an electrolytic Ni plating layer and an outermost layer comprising an electrolytic Au layer are formed.

According to the invention, the metal-coated optical fiber is characterized in that the thickness of the electrolytic Ni plating layer is 1.0-5.0 μm.

Furthermore, according to the invention, the metal-coated optical fiber is characterized in that the thickness of the electrolytic Au plating layer is 0.1-1 μm.

### BRIEF DESCRIPTION OF THE DRAWINGS

FIG. 1 is a sectional view schematically showing the structure of the metal-coated optical fiber according to the invention.

### BEST MODE FOR CARRYING OUT THE INVENTION

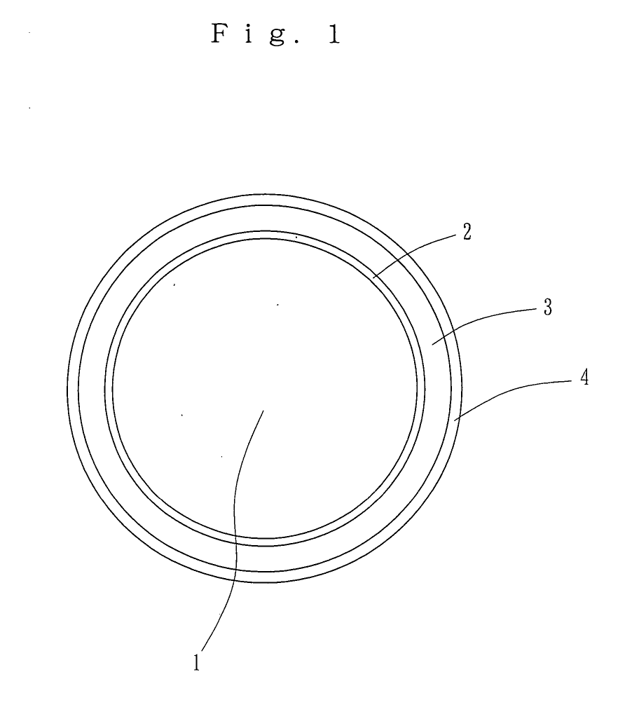

In accordance with the embodiments shown in the drawing, the present invention will be described below. FIG. 1 is a sectional view schematically showing the structure of the metal-coated optical fiber according to the invention. In this FIGURE, expediently, the thickness of metal layer which is formed on the surface of the optical fiber core wire is shown with exaggeration.

As shown in FIG. 1, on the surface of on the surface of the optical fiber core wire wherein the plastic cover is removed, the foundation layer comprising 0.1-1.0 of an electroless Ni plating layer 2, and the inner layer 3 comprising an electrolytic Ni plating layer and the outermost layer 4 comprising an electrolytic Au layer are formed.

In this invention, the reason why the metal layers are made according to the order, the Ni layer and the Au layer, on the surface of the optical fiber core wire 1 is that a Ni/Au film has a high level of soldering wettability and thereby the good soldering can be made. And the reason why the thickness of the electroless Ni plating layer 2 is between 0.01-0.51 μm is that below 0.01 μm is too thick to damage the electrolytic after that. Furthermore, above 0.5 μm, the soldering time becomes long, it is economically disincentive and when the electroless Ni plating layer is make too much thick, as mentioned above, because the internal stress and hardness of the electroless Ni plating layer 2 is high, the plasticity of the optical fiber becomes impaired, and the thick is easy to peel. Furthermore, the reason why the electrolytic Ni plating layer 3 is formed on the electroless Ni plating layer 2 is that the film speed of the electrolytic plating is faster than that of the electroless plating and if the same film thickness is plated, the electrolytic plating takes shorter time. Also, the internal stress is low because the electrolytic plating has a high-purity, the plasticity fis good and it is easy to peel.

For example, an AuSn soldering is made on a Ni/Au film according to the invention, the phenomenon that Au and Ni are dissolved in the melted solder, that is called “Solder C”, occurs.

When such soldering failure occurs and quartz is revealed on the surface of the optical fiber core wire, quartz is, the wettability against solder gets bad. Consequently, it is desirable that the thickness of the electrolytic Ni plating layer 3 of the inner layer in the metal-coated optical fiver is above 0.5 μm. However, above 4.0 μm, because the irreversibility that is the condition that the optical fiber is bent occurs, so it is desirable that the thickness is below 4.0 μm.

The Au layer 4 which is an outer layer is the layer which is established for protecting against oxidation and upgrading the soldering wettability. When Ni gets oxidated, the wettability against solder, therefore, in order to protect against oxidation of Ni layer it is desirable that the thickness of the Au layer 4 is above 0.05 μm. The wettability upgrades significantly because the Au film has a high speed of dissolving in solder. But, it is desirable that the layer 4 is below 1 μm from the economical point of view because the effect of protecting against oxidation and soldering wettability is not produced so much even when the Au layer 4 which is over 1 μm in thickness is established.

In addition, it is desirable that the electrolytic Ni plating layer 3 which is an inner layer and the electrolytic Au plating layer 4 which is an outermost layer is Ni or Au plating layer having more than 99.9% of purity.

Next, embodiments 1-5 are described in more detail as follows.

After the plastic covering of the optical fiber is peeled and removed, the fiber core wire having 125 μm of wire diameter and 20 mm of length is revealed, the surface of this fiber core wire is alkaline cleaned by potassium hydroxide, acid cleaned by sulfuric acid and prepared such as chemical polish by persulfates.

After that, the optical fiber is dipped in the solution containing Sn salt and Silane coupling agent and the surface of the fiber core wire is controlled.

After that, the optical fiber is made to a catalyst in a Pd salt solution, plated by an reduction-type electroless Ni plating bath (N.E. CHEMCAT CORPORATION makes, NIC100), and thereafter a Ni foundation layer is formed.

After that, Ni with a high-purity is electrolytically plated by sulfamic acid Ni plating solution and a Ni inner layer is formed. And Au with a high-purity is electrolytically plated by a commercially available pure Au plating solution (N.E. CHEMCAT CORPORATION makes, N44), then an Au plating layer is formed.

By above-mentioned method of the preparation, the optical fibers coated with metal which has the film thickness of embodiments 1-5 shown in the under-mentioned table 1 are formed. Furthermore, the under-mentioned table 1 also shows comparative examples 1,2.

The optical fiber coated with metal which has the film thickness of comparative examples 1,2 under the plating condition which is same with the embodiments. Example 1, the electroless Ni plating layer is 0.008 μm, the film thickness of the electroless Ni plating layer of foundation layer is thick, the Ni layer and the Au layer which are plated by electrolytically after that cannot be for formed. Furthermore, in comparative example 2 which has 1. 0 μm of electroless Ni plating layer, when a part of optical fiber core wire which is covered with metal is made to bend repeatedly, a peeling of metal coat is identified in some part.

The optical fibers of the embodiment 1-5 and the comparative example 2 are inserted in through-holes which is established stainless-steel bead and which has a diameter of 135 μm, and plated with bead by means of AuSn plating. In addition, the bead is Ni/Au plated for solder wettability of bead and AuSn plating.

By the He leak test which examines for sir-tight state of soldering part, a leak is not shown in each optical fiber of Embodiment 1-5, favorable soldering is obtained in all fibers, but, in the optical fiber of comparative example 2, solder doesn't not get wet in part where metal coat was peeled by bending test, and leak was identified.

TABLE 1

| | Electroless | Electrolytic | Electroless | | |
|---|---|---|---|---|---|
| | Ni plating | Ni plating | Au plating | Fiber | Solder |
| | Film Thickness (μm) | Film Thickness (μm) | Film Thickness (μm) | Plasticity | ability |
| Example 1 | 0.01 | 0.5 | 0.05 | Very good | Very good |
| Example 2 | 0.01 | 0.4 | 0.05 | Very good | Good |
| Example 3 | 0.2 | 1.0 | 0.2 | Very good | Very good |
| Example 4 | 0.2 | 4.0 | 0.2 | Very good | Very good |
| Example 5 | 0.5 | 6.0 | 0.2 | Good | Very good |
| Comparative | 0.008 | — | — | — | — |
| Example 1 | | | | | |
| Comparative | 1.0 | 2.0 | 0.2 | Not good | Not good |
| Example 2 | | | | | |

Described above, the present invention intends to provide a metal-coated optical fiber which is coated with metal on the surface of the optical fiber core wire wherein the plasticity is not impaired and the adherence to the optical fiber is strong, what is more, the soldering ability is good.

1-3. (canceled)

4. A metal-coated optical fiber, comprising an optical fiber core wire;
an electroless Ni plating layer disposed around the optical fiber core wire, wherein the
electroless Ni plating layer has a thickness of 0.01 to 1.0 μm;
an electrolytic Ni plating layer disposed around the electroless Ni plating layer; and
an electrolytic Au layer disposed around the electrolytic Ni plating layer.

5. The metal-coated optical fiber of claim 4, wherein the electroless Ni plating layer has a thickness of 0.01 to 0.5 μm.

6. The metal-coated optical fiber of claim 4, wherein the electrolytic Ni plating layer has a thickness of 0.4 to 4.0 μm.

7. The metal-coated optical fiber of claim 4, wherein the electrolytic Au plating layer has a thickness of 0.05 to 1 μm.
